(19) United States
(12) Patent Application Publication
(10) Pub. No.: US 2019/0030453 A1
(43) Pub. Date: Jan. 31, 2019

(54) OCEAN DESALINATION PLANT

(71) Applicant: Jaeyong Shin, Chuncheon-si (KR)

(72) Inventor: Jaeyong Shin, Chuncheon-si (KR)

(21) Appl. No.: 15/658,551

(22) Filed: Jul. 25, 2017

(51) Int. Cl. B01D 1/00; C02F 1/14; B01D 3/02; B01D 5/00

(52) U.S. Cl. CPC B01D 1/0035; C02F 1/14; C02F 2101/12; B01D 5/0066; B01D 1/0017; B01D 3/02

(57) ABSTRACT

The present application discloses a desalination plant that desalinates ocean water. A water gate of the desalination plant is opened to allow salt water from an ocean to flow into an isolated salt water zone. Once desired amount of salt water enters the desalination plant, the water gate is closed to prevent both further salt water from flowing into and the isolated salt water from flowing out of the isolated salt water zone. An isolation wall prevents the isolated salt water from flowing into a desalted water zone. The isolated salt water in the isolated salt water zone is heated by using sunlight and electric heating elements to be vaporized. The sunlight entering the isolated salt water zone is reflected on multiple reflective surface to further heat the isolated salt water. The vaporized water flows towards the desalted water zone, and subsequently cools down to condense into desalted water. The desalted water in the desalted water zone flows through an exit pipe and is collected at a reservoir.

### TECHNICAL FIELD

The subject matter of the application relates to an ocean desalination plant that provides water without salt.

### BACKGROUND ART

Despite being adjacent to an ocean, many parts of the world, such as California, have problem providing enough fresh water to meet their demand. This is mainly due to the fact that salt water from the ocean is inappropriate for most types of water usage, such as agricultural or cleaning. Therefore, a cost efficient way of desalinating salt water is desired.

### OBJECT AND SUMMARY OF THE INVENTION

An object of the present application is to provide a desalination plant that can desalt salt water from an ocean in large scale without a need to manually remove separated salt. Another object of the present application is to increase the energy efficiency of the desalination process by using sunlight and gravity. In addition, an object of the present application is to remove the necessity to have an electrically operated feed that feeds salt water into a desalination plant.

In this application, words importing the singular include the plural and vice versa.

A desalination plant according to an exemplary embodiment of this application that desalinates salt water from an ocean using solar energy includes a roof, a water gate connected to the roof, a base portion connected to the water gate, and an isolation wall projecting from the base.

The isolation wall is configured to prevent salt water from flowing from a first side of the isolation wall to a second side of the isolation wall. An isolated salt water zone is formed on the first side of the isolation wall. A desalted water zone is formed on the second side of the isolation wall. The water gate in an open state is configured to allow salt water to flow from an ocean into the isolated salt water zone. The water gate in a closed state is configured to prevent salt water from flowing into the desalination plant. When the water gate is in the closed state, isolated salt water is isolated from the ocean and contained in the isolated salt water zone, and desalted water is collected at the desalted water zone.

The roof of the desalination plant includes a transparent roof portion and an opaque roof portion. The transparent roof portion is configured to allow sunlight to enter the isolated salt water zone, and the opaque roof portion is configured to block sunlight from entering the desalination plant through the opaque roof portion.

The base portion of the desalination plant includes a thermal insulator base portion and a thermal conductor base portion. The thermal insulator base portion forms a first base support for the isolated salt water zone, and the thermal conductor base portion forms a second base support for the desalted water zone.

The thermal insulator base portion, the water gate, and the isolation wall of the desalination plant have lower thermal conductivity than the thermal conductor base portion. In addition, the opaque roof portion has higher thermal conductivity than the isolation wall.

In the exemplary embodiment, a peak of inner the surface of the opaque roof portion, which faces inside of the desalination plant, has the highest altitude among the inner surface of the roof portion that faces inside of the desalination plant.

The desalination plant also has an exit pipe with a first end connected to the desalted water zone and a second end connected to a reservoir. The exit pipe is configured to move the desalted water from the desalted water zone to the reservoir.

In the exemplary embodiment, a portion of an inner surface of the thermal insulator base portion, which faces inside of the desalination plant, that is directly connected to the water gate has lower altitude than any other portion of the inner surface of the thermal insulator base portion.

A portion of inner surface of the thermal conductor base portion, which faces inside of the desalination plant, is directly connected to the first end of the exit pipe, and such portion of the inner surface has lower altitude than any other portion of the inner face of the thermal conductor base portion.

The exemplary embodiment of the desalination plant may also include one or more electric heating elements placed inside the isolated salt water zone.

In the exemplary embodiment of the desalination plant, a surface of the isolation wall, a surface of the water gate, and the inner surface of the thermal insulator base portion, which all face the isolated salt water zone, reflect light. In addition, the exemplary embodiment of the desalination plant further includes side walls that are connected to each of two sides of the water gate. Specifically, side walls are horizontally connected to two sides of the water gate. Surfaces of the side walls facing the isolated salt water zone also reflect light.

The exemplary embodiment of the desalination plant may also include an optional pump connected to the exit pipe that pumps the desalted water from the desalted water zone to the reservoir.

### BRIEF DESCRIPTION OF THE DRAWINGS

FIG. 1 is a cross-sectional view of a desalination plant 1.

FIG. 2 shows a perspective view of the desalination plant 1 viewed from the ocean side facing a water gate. Ocean is omitted in FIG. 2 for clarity.

FIG. 3 shows a perspective view of the desalination plant 1 viewed from the same point of view as FIG. 1.

FIG. 4 shows a perspective view of the desalination plant 1 viewed from above. Ocean is omitted in FIG. 4 for clarity.

### DESCRIPTION OF EMBODIMENTS

Hereinafter, a description will be made below of an embodiment of the subject matter of the present application with reference to the figures.

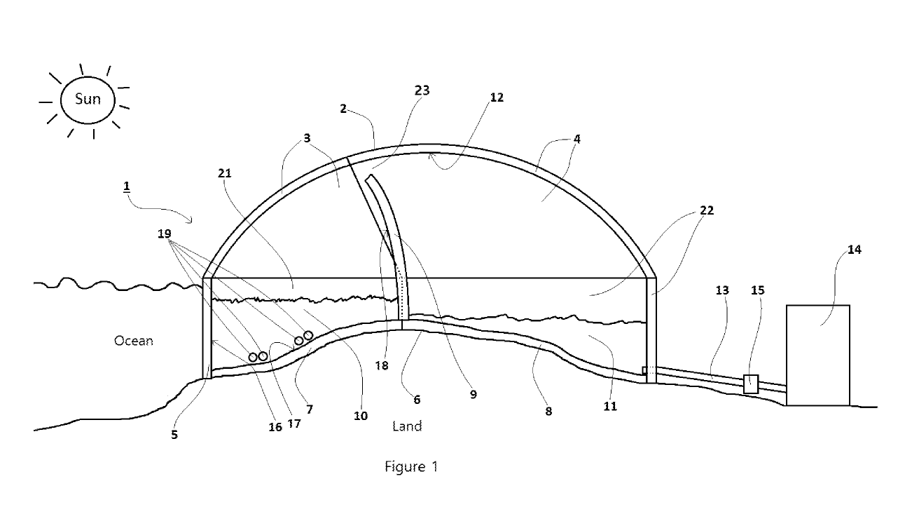

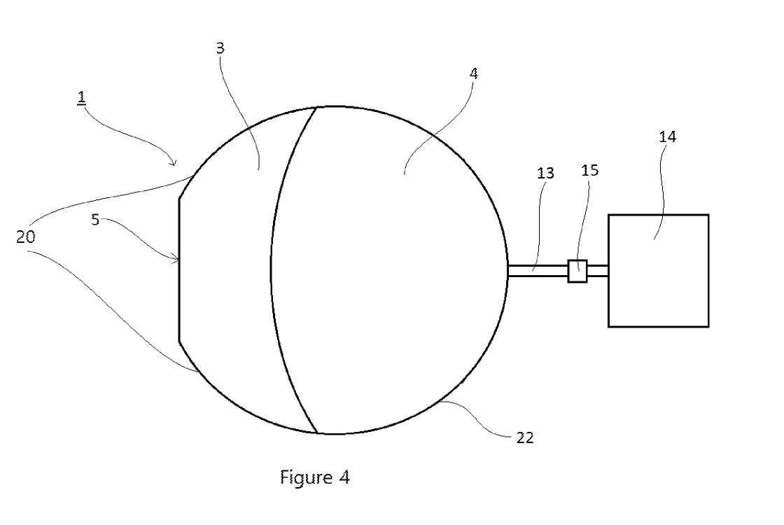

FIGS. 1-4 show an exemplary embodiment of the subject matter of the present application. As shown in FIG. 1, the desalination plant 1 includes a roof 2. In this exemplary embodiment, the roof 2 is substantially dome-shaped. The shape of the roof 2, however, is not limited to a dome shape. The roof 2 includes a transparent roof portion 3 and an opaque roof portion 4. The base portion 6 includes a thermal insulator base portion 7 and a thermal conductor base portion 8. The thermal insulator base portion 7 is connected to the water gate 5. An isolation wall 9 is erected from the base portion 6. The isolation wall 9 divides the desalination plant 1 into an isolated salt water zone 10 and a desalted water zone 11. An exit pipe 13 is connected to the desalted water zone 11 in one end and connected to a reservoir 14 on the other end. The exit pipe 13 may include an optional pump 15 to pump water out from the desalted water zone 11.

The transparent roof portion 3 preferably comprises a material that is transparent, such as, including without limitation, glass or polymethyl methacrylate, to allow light to pass through, or a translucent material. The transparent roof portion 3 may either be formed entirely of a transparent material or may be formed using the conventional method of placing the transparent material in a supporting frame.

The transparent roof portion 3 allows sunlight to enter the isolated salt water zone 10. The sunlight provides heat to the isolated salt water zone 10 and facilitates vaporization of the isolated salt water in the isolated salt water zone 10. The opaque roof portion 4 may be made of a material that is opaque and low cost, such as, including without limitation, concrete. Also, as it is desirable for the opaque roof portion 4 to have high thermal conductivity, the opaque roof portion 4 may also be made of material that is opaque and has high thermal conductivity, such as, including without limitation, concrete, a copper-nickel alloy or an aluminum-brass alloy.

The opaque roof portion 4 is configured to block sunlight from entering the desalination plant 1 through the opaque roof portion 4, which reduces the amount of heat entering the desalted water zone 11. Furthermore, due to the high thermal conductivity of the opaque roof portion 4, heat is rapidly transferred from the desalted water zone 11 to the outside. Consequently, the temperature of the desalted water zone 11 is lower than the temperature of the isolated salt water zone 10.

A peak 12 of the roof 2 is the farthest point of the roof 2 in the vertical direction with respect to the mean sea level among the portions of inner surface of the roof 2. In this application, the vertical direction is defined as the direction that is vertical to the layer of an ocean at the mean sea level. In other words, the peak 12 has the highest altitude among the portions of the inner surface of the roof 2. In this embodiment, the peak 12 is preferably located at the inner surface of the opaque roof portion 4 that faces the inside of the desalination plant 1. Since vaporized water is lighter than both diatomic oxygen and diatomic nitrogen, both of which are major constituents of the atmospheric air, vaporized water in the isolated salt water zone 10 moves vertically upward towards the roof 2.

Then, the vaporized water moves along the roof 2 towards the peak 12. Because the peak 12 has the highest altitude among the portions of the inner surface of the roof 2, the vaporized water gathers around the peak 12 in the desalted water zone 11. As mentioned above, the desalted water zone 11 has lower temperature relative to the isolated salt water zone 10. Therefore, the vaporized water around the peak 12 cools down and eventually falls down towards the thermal conductor base portion 8 in liquid form. Consequently, desalted water is collected on the thermal conductor base portion 8.

The water gate 5 is configured to be opened and closed to control water flow into or out of the desalination plant 1. Any conventional floodgate structure may be used for the water gate 5, such as, but not limited to, the following: bulkhead gates, hinged crest gates, radial gates, drum gates, roller gates, clam shell gates, or fuse gates. The water gate 5 may be operated electrically. When the water gate 5 is in the closed state, additional ocean water is prevented from entering into the desalination plant 1. For example, the water gate 5 may be in the closed state during the day to produce desalted water and be in the open state during the night to refill salt water into the isolated salt water zone 10. Alternatively, the water gate 5 may be opened and closed multiple times throughout the day if the isolated salt water zone 10 needs a refill due to a rapid vaporization of the isolated salt water.

The water gate 5 may be made of a material with high thermal inertia, such as, including without limitation, a compressed earth block. Thermal insulation property of the water gate 5 reduces the heat transferred from the isolated salt water zone 10 to the outside. This increases the temperature discrepancy between the isolated salt water zone 10 and the desalted water zone 11, and contains the heat in the isolated salt water zone 10.

A water gate reflective surface 16 is a surface of the water gate 5 that faces the isolated salt water zone 10. The water gate reflective surface 16 is configured to reflect light. The water gate reflective surface 16 may obtain reflective property by, for example, having the surface of the water gate 5, which faces the isolated salt water zone 10, coated with a light reflecting paint or a metal. Alternative to being a surface of the water gate 5, the water gate reflective surface 16 may be a layer of mirror or other light reflecting material, such as, but not limited to, biaxially-oriented polyethylene terephthalate or aluminum composite that is attached to the surface of the water gate 5 that faces the isolated salt water zone 10. Reflectivity of the water gate reflective surface 16 should preferably be above 80%, but higher reflectivity is better as long as it is cost efficient. The water gate reflective surface 16 reflects sunlight back to the isolated salt water zone 10, further heating the isolated salt water zone 10.

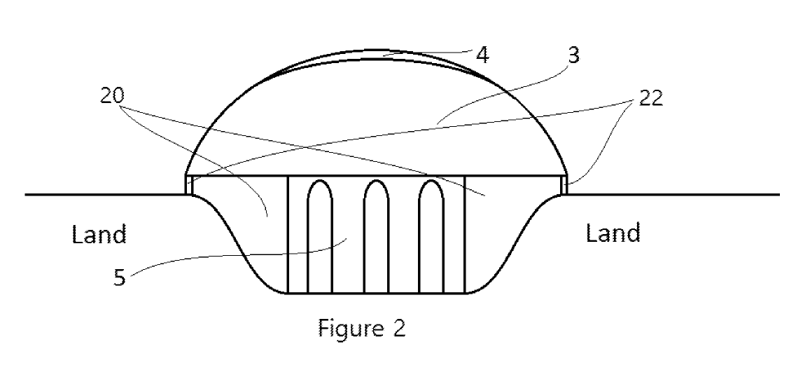

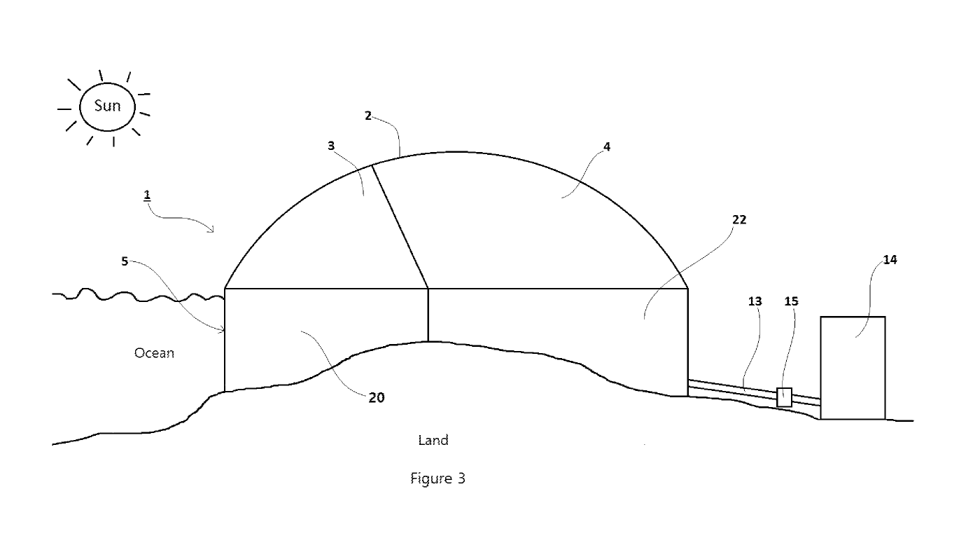

As shown in FIGS. 2 and 3, two sides of the water gate 5 are connected to first side walls 20. Specifically, the first side walls 20 are connected to the water gate 5 in a horizontal direction. In this application, the horizontal direction refers to a direction that is perpendicular to the vertical direction. The first side walls 20 are connected to a second side wall 22. In the exemplary embodiment, the first side walls 20 meet the second side wall 22 in the horizontal direction at locations such that the first side walls 20 do not cover the desalted water zone 11. That is, the first side walls 20 do not come into contact with the desalted water zone 11. The first side walls 20 preferably have waterproof property.

As shown in FIG. 1, side reflective surfaces 21 are configured to reflect light. The side reflective surfaces 21 may obtain reflective property by, for example, having the surface of the first side walls 20, which face the isolated salt water zone 10, coated with a light reflecting paint or metal. Alternative to being a surface of the first side walls 20, the side reflective surfaces 21 may be a layer of mirror or other light reflecting material, such as, but not limited to, biaxially-oriented polyethylene terephthalate and aluminum composite that is attached to the surface of the first side walls 20 that face the isolated salt water zone 10. Reflectivity of the side reflective surfaces 21 is preferably above 80%, but higher reflectivity is better as long as it is cost efficient. The side reflective surfaces 21 reflect sunlight back to the isolated salt water zone 10, further heating the isolated salt water zone 10.

In addition, the first side walls 20 are made of material with high thermal inertia, such as, including without limitation, a compressed earth block. This thermal insulation property of the first side walls 20 reduces heat dissipating from the isolated salt water zone 10 to outside and, therefore, contains heat in the isolated salt water zone 10.

The second side wall 22 is preferably made of a material that has high thermal conductivity, such as, including without limitation, concrete. Due to the high thermal conductivity of the second side wall 22, heat is rapidly transferred from the desalted water zone 11 to the outside. As a result, the temperature of the desalted water zone 11 is lower than the temperature of the isolated salt water zone 10. The second side wall 22 preferably has waterproof property.

As described above, the base portion 6 includes a thermal insulator base portion 7 and a thermal conductor base portion 8. The thermal insulator base portion 7 forms a base support of the isolated salt water zone 10. In other words, ocean water entering into the isolated salt water zone 10 through the water gate 5 lands on the thermal insulator base portion 7.

A base reflective surface 17 is configured to reflect light. The base reflective surface 17 may obtain reflective property by, for example, coating the surface of the thermal insulator base portion 7, which faces the isolated salt water zone 10, with a light reflecting paint or metal. Alternative to being a surface of the thermal insulator base portion 7, the base reflective surface 17 may be a layer of mirror or other light reflecting material, such as, but not limited to, biaxially-oriented polyethylene terephthalate and aluminum composite that is attached to the surface of the thermal insulator base portion 7 that faces the isolated salt water zone 10. Reflectivity of the base reflective surface 17 is preferably above 80%, but higher reflectivity is better as long as it is cost efficient. The base reflective surface 17 reflects sunlight back to the isolated salt water zone 10, further heating the isolated salt water zone 10. In addition, the thermal insulator base portion 7 is made of a material with high thermal inertia such as, including without limitation, a compressed earth block. This thermal insulation property of the thermal insulator base portion 7 reduces heat dissipating from the isolated salt water zone 10 to the outside and, therefore, contains heat in the isolated salt water zone 10. In addition, the thermal insulator base portion 7 preferably has waterproof property.

A portion of the thermal insulator base portion 7 that is directly connected to the water gate 5 preferably has lower altitude than any other portion of the thermal insulator base portion 7. Specifically, a portion of the base reflective surface 17 located at the portion of the thermal insulator base portion 7, which is directly connected to the water gate 5 preferably has lower altitude than any other portion of the base reflective surface 17. Accordingly, due to gravity, salt sediments in the isolated salt water zone 10 have the tendency to move towards the water gate 5 and move out of the isolated salt water zone 10 when the water gate 5 is open. In other words, the thermal insulator base portion 7 is preferably slanted to facilitate removal of the salt sediments in the isolated salt water zone 10. When desalination is in the process, salt concentration of the isolated salt water in the isolated salt water zone 10 may temporarily be higher than the salt concentration of the ocean water outside the isolated salt water zone 10, because the water gate 5 is closed and the isolated salt water in the isolated salt water zone 10 is vaporized. However, when the water gate 5 is open, the ocean water and the isolated salt water move freely in and out of the isolated salt water zone 10. Eventually, the salt concentration of the isolated salt water in the isolated salt water zone 10 will be reduced to matches the salt concentration of the ocean water outside the isolated salt water zone 10, even if some of the salt sediments dissolve in the salt water coming into the isolated salt water zone 10.

Accordingly, in this exemplary embodiment, one can remove the salt sediments and reduce the salt concentration of the isolated salt water in the isolated salt water zone 10 by simply opening the water gate 5. In other words, it is not necessary to manually remove the salt sediments and pump the ocean water into the isolated salt water zone 10.

One or more electric heating elements 19 may be placed in the isolated salt water zone 10. Conventional electric heating elements, such as, but not limited to, nickel chrome alloy strips and ribbons, may be used as the electric heating elements 19. The electric heating elements 19 preferably have high corrosion resistance to salt water (for example, by having a corrosion resistant coating and/or being made of corrosion resistant materials such as nickel chrome alloy). The electric heating elements provide additional heat (in addition to heat from sunlight) to further facilitate vaporization of the isolated salt water in the isolated salt water zone 10. Preferably, the combined amount of heat from sunlight and electric heating elements 19 increases the temperature of the isolated salt water in the isolated salt water zone 10 beyond its boiling point. As a result, the electric heating elements 19 may be used minimally or not used at all on a very sunny and hot day, while the electric heating elements 19 may be used more extensively on a cold or foggy day.

The thermal conductor base portion 8 forms the base of the desalted water zone 11. The thermal conductor base portion 8 is made of a material with high thermal conductivity and high corrosion resistance, such as, including without limitation, copper-nickel or aluminum-brass alloy. Preferably, the thermal conductor base portion 8 has waterproof property to prevent the desalted water from soaking into the ground below the thermal conductor base portion 8. Due to the high thermal conductivity of the thermal conductor base portion 8, heat is rapidly transferred from the desalted water zone 11 to the outside. Accordingly, the vaporized water around the peak 12 is further facilitated to condense into liquid form. As mentioned above, the exit pipe 13 is connected to the desalted water zone 11 on one end and connected to a reservoir 14 on the other end. Preferably, the end of the exit pipe 13 connected to the desalted water zone 11 is either in direct contact with the thermal conductor base portion 8 or is integrated with the thermal conductor base portion 8 as a drain hole. In case the end of the exit pipe 13 is formed as a drain hole, the exit pipe 13 extends out of the thermal conductor base portion 8 as a drain pipe.

A portion of the thermal conductor base portion 8 that is in direct contact with the end of the exit pipe 13 (or integrated into the end of the exit pipe 13) preferably has lower altitude than any other portion of the thermal conductor base portion 8. To be clear, the inner surface, which faces the desalted water zone 11, of the portion of the thermal conductor base portion 8 that is in direct contact with the end of the exit pipe 13 (or integrated into the end of the exit pipe 13) preferably has lower altitude than the rest of the portions of the inner surface of the thermal conductor base portion 8. Furthermore, the reservoir 14 may be placed at a lower altitude than that of such portion of the thermal conductor base portion 8. As a result, due to gravity, the desalted water collected on the thermal conductor base portion 8 is drained at the end of the exit pipe 13 connected to the desalted water zone 11, and flows through the exit pipe 13 to enter the reservoir 14 through the other end of the exit pipe 13 that is connected to the reservoir 14. In other words, the desalted water is removed from the desalination plant 1 and collected at the reservoir 14 without using electricity in this embodiment. Therefore, the net energy input needed for collecting desalted water using the desalination plant 1 is reduced. In addition, an optional pump 15 may be connected to the exit pipe 13 to pump the desalted water out of the desalted water zone 11 and into the reservoir 14. The use of the optional pump 15 provides more flexibility with respect to elevation of the thermal conductor base portion 8 and the reservoir 14. Specifically, if the optional pump 15 is used, it is not necessary for the portion of the thermal conductor base portion 8 that is in direct contact with the end of the exit pipe 13 to have lower altitude than the rest of the thermal conductor base portion 8. In other words, the reservoir may be placed at any altitude in such case.

The isolation wall 9 is erected and extends away from the base portion. In this exemplary embodiment, a gap 23 is formed between the roof 2 and the isolation wall 9. The gap 23 allows vaporized water to flow from the isolated salt water zone 10 to the desalted water zone 11. In this exemplary embodiment, the isolation wall 9 initially extends vertically from the base portion 6 and curves toward the isolated salt water as the isolation wall 9 extends further away from the base portion 6. This configuration allows an increased amount of light to be reflected back to the isolated salt water zone 10. However, the isolation wall 9 may also be formed in different shapes. For example, the isolation wall 9 may be erected straight from the base portion 6 in the vertical direction or may be erected at a certain angle such that the isolation wall 9 extends away from the isolated salt water zone 10. If the isolation wall 9 is erected at such angle, the size of the desalted water zone 11 is reduced. Therefore, larger portion of the roof 2 may be formed as the transparent roof portion 3 such that more sunlight is allowed to enter the isolated salt water zone 10.

In this exemplary embodiment, the isolation wall 9 is erected at an end of the thermal insulator base portion 7 where the thermal insulator base portion 7 is in contact with the thermal conductor base portion 8. Such positioning of the isolation wall 9 is to reduce the loss of heat in the isolated salt water zone 10. Furthermore, location of the isolation wall 9 is determined such that condensed water falling down vertically from the peak 12 either falls directly on the thermal conductor base portion 8 or falls down on the isolation wall 9 and slides down towards the conductor base portion 8. That is, when an imaginary vertical straight line is drawn from the peak 12 towards the ground, the imaginary vertical straight line contacts either the conductor base portion 8 or a surface of the isolation wall 9 that faces desalted water zone 11. However, this embodiment does not exclude different positioning of the isolation wall 9.

An isolation wall reflective surface 18 is a surface of the isolation wall 9 that faces the isolated salt water zone 10. The isolation wall reflective surface 18 is configured to reflect light. The isolation wall reflective surface 18 may obtain reflective property by, for example, having the surface of the isolation wall 9, which faces the isolated salt water zone 10, coated with a light reflecting paint or metal. Alternative to being a surface of the isolation wall 9, the isolation wall reflective surface 18 may be a layer of mirror or other light reflecting material, such as, but not limited to, biaxially-oriented polyethylene terephthalate and aluminum composite that is attached to the surface of the isolation wall 9 that faces the isolated salt water zone 10. Reflectivity of the isolation wall reflective surface 18 is preferably above 80%, but higher reflectivity is better as long as it is cost efficient. The isolation wall 9 may be made of a material with high thermal inertia, such as, including without limitation, a compressed earth block or an insulating concrete form. This thermal insulation property of the thermal insulator base portion 7 reduces the heat dissipated from the isolated salt water zone 10 to the desalted water zone 11; therefore, the heat is contained in the isolated salt water zone 10.

Hereinafter, the operation of the desalination plant 1 will be briefly explained.

On one hand, heat is effectively collected and contained at the isolated salt water zone 10. Sunlight enters the isolated salt water zone through the transparent roof portion 3 and heats the isolated salt water zone 10 and the isolated salt water in the isolated salt water zone 10. Most of the sunlight is reflected one or more times on water gate reflective surface 16, base reflective surface 17, the isolation wall reflective surface 18, and the side reflective surfaces 21. In addition, the heat entering the isolated salt water zone 10 is effectively contained in the isolated salt water zone 10 due to low thermal conductivity of the water gate 5, the thermal insulator base portion 7, and the first side walls 20. This configuration allows effective heating of the isolated salt water in the isolated salt water zone 10 and effective retaining of the heat inside the isolated salt water zone 10, both of which facilitate vaporization of the isolated salt water. If additional heat is needed, the electric heating elements 19 may be used to further heat the isolated salt water.

On the other hand, the desalted water zone 11 is substantially encapsulated by the opaque roof portion 4, the conductor base portion 8, isolation wall 9, and the second side wall 22, except at the gap 23. Only little or no sunlight enters the desalted water zone 11; only small amount of the heat transfers from the isolated salt water zone 10 to the desalted water zone 11; and heat effectively dissipates from the desalted water zone 11 to outside via the opaque roof portion 4, the conductor base portion 8, and the second side wall 22. Consequently, the desalted water zone 11 is maintained at lower temperature than the isolated salt water zone 10, and vaporized water entering the desalted water zone 11 through the gap 23 condenses in the desalted water zone 11 due to the lower temperature. The desalted water collected, due to the condensation, on the thermal conductor base portion 8 flows out of the desalination plant 1 and enters the reservoir 14 through the exit pipe 13. The optional pump 15 may be used to facilitate the flow of the desalted water.

The water gate 5 may be opened to remove salt sediment from, and to provide additional salt water to, the isolated salt water zone 10.

What is claimed is:

1. A desalination plant configured to desalinate salt water from an ocean using solar energy comprising:
a roof;
a water gate connected to the roof;
a base portion connected to the water gate; and
an isolation wall projecting from the base,
wherein the isolation wall is configured to prevent the salt water from flowing from a first side of the isolation wall to a second side of the isolation wall,
wherein an isolated salt water zone is formed on the first side of the isolation wall,
wherein a desalted water zone is formed on the second side of the isolation wall,
wherein the water gate is configured to switch between an open state and a closed state,
wherein the water gate in the open state is configured to allow salt water to flow from the ocean into the isolated salt water zone,
wherein the water gate in the closed state is configured to prevent the salt water from flowing into the desalination plant,
wherein isolated salt water is isolated from the ocean and contained in the isolated salt water zone when the water gate is in the closed state, and
wherein desalted water is collected at the desalted water zone.

2. The desalination plant of claim 1,
wherein the roof comprises a transparent roof portion and an opaque roof portion,
wherein the transparent roof portion is configured to allow sunlight to enter the isolated salt water zone, and
wherein the opaque roof portion is configured to block sunlight from entering the desalination plant through the opaque roof portion.

3. The desalination plant of claim 1,
wherein the base portion comprises a thermal insulator base portion and a thermal conductor base portion,
wherein the thermal insulator base portion forms a first base support for the isolated salt water zone, and
wherein the thermal conductor base portion forms a second base support for the desalted water zone.

4. The desalination plant of claim 3,
wherein the thermal insulator base portion has lower thermal conductivity than the thermal conductor base portion.

5. The desalination plant of claim 3,
wherein the water gate has lower thermal conductivity than the thermal conductor base portion.

6. The desalination plant of claim 2,
wherein the opaque roof portion has higher thermal conductivity than the isolation wall.

7. The desalination plant of claim 4,
wherein the isolation wall has lower thermal conductivity than the thermal conductor base portion.

8. The desalination plant of claim 2,
wherein a peak is located at inner surface of the opaque roof portion that faces inside of the desalination plant, and
wherein the peak has highest altitude among inner surface of the roof portion that faces inside of the desalination plant.

9. The desalination plant of claim 1 further comprising:
an exit pipe,
wherein a first end of the exit pipe is connected to the desalted water zone,
wherein a second end of the exit pipe is connected to a reservoir, and
wherein the exit pipe is configured to move the desalted water from the desalted water zone to the reservoir.

10. The desalination plant of claim 3,
wherein a portion of inner surface of the thermal insulator base portion, which faces inside of the desalination plant, that is directly connected to the water gate has lower altitude than any other portion of the inner surface of the thermal insulator base portion.

11. The desalination plant of claim 8,
wherein a portion of inner surface of the thermal conductor base portion, which faces inside of the desalination plant, is directly connected to the first end of the exit pipe, and
wherein the portion of the inner surface of the thermal conductor base portion that is directly connected to the first end of the exit pipe has lower altitude than any other portion of the inner face of the thermal conductor base portion.

12. The desalination plant of claim 1 further comprising one or more electric heating elements placed inside the isolated salt water zone.

13. The desalination plant of claim 1, wherein a surface of the isolation wall facing the isolated salt water zone is configured to reflect light.

14. The desalination plant of claim 1, wherein a surface of the water gate facing the isolated salt water zone is configured to reflect light.

15. The desalination plant of claim 3, wherein a surface of the thermal insulator base portion facing the isolated salt water zone is configured to reflect light.

16. The desalination plant of claim 1 further comprising:
side walls horizontally connected to the water gate,
wherein surfaces of the side walls facing the isolated salt water zone are configured to reflect light.

17. The desalination plant of claim 9 further comprising:
an optional pump connected to the exit pipe,
wherein the optional pump is configured to pump the desalted water from the desalted water zone to the reservoir.
